(19) United States
(12) Patent Application Publication
(10) Pub. No.: US 2007/0081875 A1
(43) Pub. Date: Apr. 12, 2007

(54) Foamed adhesive for casing-in

(75) Inventors: David W. Lydzinski, Belle Mead, NJ (US); Richard M. Stamper, Marietta, GA (US)

Correspondence Address: NATIONAL STARCH AND CHEMICAL COMPANY, P.O. BOX 6500, BRIDGEWATER, NJ, 08807-3300, US

(73) Assignee: National Starch and Chemical Investment Holding Corporation

(21) Appl. No.: 11/244,799

(22) Filed: Oct. 6, 2005

(51) Int. Cl. B42C 11/00

(52) U.S. Cl. 412/5

(57) ABSTRACT

A foamed adhesive for the production of books, more preferably hard cover books. The adhesive is used in casing-in operations to attach end sheets of a book block to a hard cover.

### FIELD OF THE INVENTION

The invention relates to the field of bookbinding, more specifically to casing-in applications.

### BACKGROUND OF THE INVENTION

In recent years, substantial interest has grown in the bookbinding, publishing and printing industries and in the graphic arts area generally, with respect to the development of improved adhesive compositions which lend themselves to casing-in and casemaking.

Casemaking refers to the production of the case or cover, i.e., the outer shell, of a hard bound book. During this process, the material that forms the outer covering of the book is bonded to binder boards to form a “hard” cover. Animal glues are conventionally used for this process.

The preformed case is then joined to the end sheets of a book block to form the completed book cover by a “casing-in” process wherein the book block is fastened into its hard cover or “case”. In casing-in, an adhesive is evenly applied to the outside of both the first and last pages (“endpapers” or “end sheets”) of the book block, the adhesive-coated book block is inserted into the preformed case in the position in which the two are to be adhered. The book block and case are then pressed together so the adhesive will bond both together.

Casing-in is typically accomplished using a water based solution or emulsion. While aqueous liquid adhesives are safe and easy to handle, water-based adhesives have a number of disadvantages associated with their use. Water-based liquid adhesives require significant drying times, require long set times, and the water contained within them tends to swell the substrates surfaces that come in contact with the adhesive, leading to warpage, wrinkling, curling or bending of the substrate. Thus, moisture from water based systems can be detrimental to a finished book. Moisture from the adhesive can migrate into the binding board or book block causing cockeling or waviness in the end sheets and/or resulting in warpage of the cover. The presence of moisture may also result in curvature of the cover in relation to the book block, as can lack of register of the cover with the book block. In addition, problems such as warping increases the costs associated with bookbinding due to unacceptable appearance, waste and the like.

There is a continuing need in the art to develop improved adhesives for faster processing times for the casing-in of book bindings and for adhesives that are safe, effective and provide a substantial saving in terms of cost and reduction in manufacturing defects. The invention fulfills this need.

### SUMMARY OF THE INVENTION

It is an object of the invention to provide an improved process of casing-in bound books which provides good adhesion of the end papers to the case and cover material while maintaining or increasing processing speeds during the casing-in operation. The invention provides an adhesive for use in casing-in which minimizes warpage, reduces costs and allows equipment to run in a fast and efficient manner.

One embodiment of the invention provides a process of forming a bound book comprising the steps of:
(a) applying a foamed water based adhesive to the outside of the first and last pages of a book block;
(b) inserting the adhesives coated book block into a preformed case in the position in which the two are to be adhered; and
(c) pressing together the book block and case to bond the book block to the case.

Adhesives for use in the practice of the invention include, but are not limited to, synthetic resins, natural rubbers, starches and/or dextrins. The adhesives of the invention can be formulated as an emulsion or a solution. Adhesives comprising single copolymer emulsions as well as blends of two or more copolymers may be used in the practice of the invention. The adhesives may comprise a mixture of polymer emulsions, such as but not limited to a mixture of vinyl acetate containing polymer emulsions.

The amount of air dispersed in the adhesive will typically vary from about 10% (by volume) up to about 50% (by volume) or greater.

Another embodiment of the invention provides bound books. The book comprises a preformed case bound to a book block, wherein the case is bonded to the book block with a foamed aqueous based adhesive.

### DETAILED DESCRIPTION OF THE INVENTION

In today's competitive marketplace it is important to maintain manufacturing costs at a minimum. This includes reducing costs associated with manufacture of books. Such costs include the costs of the materials required to make the book (e.g., paper, board stock and cover stock, adhesive and the like) and costs associated with defects (e.g., materials that must be discarded due to unacceptable strength, appearance or the like).

The invention is directed to the use of a foamed water based adhesive in casing-in operations to attach the end sheets of a book block to a preformed case. Use of the invention reduces cost of the adhesive, i.e., requires less adhesive and provides a substantial savings by reducing defects in manufactured goods.

During casemaking, a covering material is passed along a conveyor during which time binder boards are mated onto the adhesive coated covering material. The surplus covering material is folded over on to the binder board in a two step process known as “turning in” in which either the sides are folded in first and the ends are folded in second resulting in an overlap of the ends over the sides, or the ends are folded in first and the sides second. These are also called “turn-ins.” Thus, a preformed case or book cover for hardbound books are comprised of a “sandwich” or laminate consisting of the cover material, a casemaking adhesive (generally animal glue), and a cover board.

The board or binder board stock is generally chip board that has been compressed to give a high bursting strength board, sometimes designated chestnut cover board. Cover stock materials useful for making book covers include, for example, cloth, paper, leather, vinyl, polyethylene, composite materials such as paper or cloth laminated to polyethylene, polyester, or “mylar,” and polypropylene, woven fabric, pryoxylin, vinyl or other resin impregnated or coated fabric. Many other types of board stock and cover stock not mentioned herein are used in the bookbinding art and are encompassed for use in the practice of the invention.

The invention is directed to an adhesive suitable for use in casing-in operations. During the casing-in process, a book block is laminated to the inside of the cover of a hard bound book (a preformed case) by coating the outside of the end sheets of the book block with the adhesive, and then bonding the cover to the end sheets. The present invention is directed to a method of attaching a hard cover to end sheets of an inner book block. The method of the invention comprises applying a foamed water-based adhesive to the end sheets of the book block and attaching a preformed case to the end sheets.

The foamed adhesive exhibits aggressive tack, has good machining properties, and adheres to a wide variety of board stock and cover stock material (turn-ins). The adhesive does not fully penetrate the board stock, which would ruin the case by causing warping of the cover, and does not cause waviness in the end sheets.

The invention provides an adhesive that can advantageously be used in the production of books, in particular hard cover books. The adhesive is safe and effective, exhibits faster set times, and exhibits reduced moisture content, which reduces the swelling affect of water on the paper fibers. Since use of the invention reduces or eliminates warpage and the like commonly encountered using prior art water-based adhesives, the invention provides a substantial cost savings both in terms of raw materials and in terms of reduction of defective material.

One embodiment of the invention is directed to the use of an adhesive, more particularly a water-based adhesive composition, in its foamed state. The adhesive is used during the casing-in process to laminate the book block to the cover of a book, e.g., a hard bound book.

Another embodiment of the invention is directed to an article of manufacture comprising a foamed water based adhesive, in particular books, including but not limited to hard cover books.

Yet another embodiment of the invention is directed to a method for bonding materials together which comprises applying a foamed water based adhesive composition to a first substrate, bringing a second substrate in contact with the adhesive composition applied to the first substrate, and subjecting the applied composition to conditions which will allow the composition to form a set bond. In the practice of the invention, one of said substrates is a substantially rigid paper board or plastic cover material and the other substrate is paper.

Adhesives used in accordance with the invention comprise synthetic and/or natural ingredients. When modified and mechanically agitated with air, these adhesives form highly stable, consistent foams that can be applied to a substrate and used to effectively bond the substrate to a second substrate. Benefits of using the foamed adhesive of the invention include improved economics and performance, such as reduced penetration into substrates, reduced moisture and faster set times. It has been discovered that adding air bubbles to the adhesive significantly reduces moisture content without affecting adhesive performance. Faster drying times and a substantially reduction in incidence of warping and/or wrinkling encountered in prior art methods are possible when books are prepared in accordance with the invention.

Adhesives for use in the practice of the invention include, but are not limited to, synthetic resins, natural rubbers, starches and/or dextrins. The adhesives of the invention can be formulated as an emulsion or a solution. Adhesives comprising single copolymer emulsions as well as blends of two or more copolymers are contemplated for use in the practice of the invention. The adhesives may comprise a mixture of polymer emulsions, such as but not limited to a mixture of vinyl acetate containing polymer emulsions.

In one embodiment, the foamed adhesives comprise at least one resin emulsion, and may also comprise at least one filler as well as other additives. Typically, the foamed adhesive comprises more than about 30%, more typically from about 50% by weight to about 100%, more preferably 55% by weight to about 85% by weight of the resin emulsion, and from 0% by weight to about 50% by weight, more typically from about 5% to about 20% % by weight of filler and/or other conventional additives.

A preferred adhesive comprises at least one vinyl acetate containing emulsion. Included are emulsions comprising vinyl acetate, emulsions comprising vinyl acetate copolymers such as ethylene vinyl acetate or propylene vinyl acetate, and various mixtures thereof.

Preferred are mixtures of vinyl acetate containing emulsions and vinyl acetate copolymer containing emulsions. Included are ethylene vinyl acetate, copolymers of vinyl acetate and other acrylates such as 2-ethylhexylacrylate, and vinyl acetate homopolymers. Examples are emulsions comprising a vinyl acetate polymer and/or copolymer and an acrylic copolymer. The acrylic copolymer component present in each polymer emulsion present in the polymer mixture may be different, e.g., one is dioctylmaleate and the other butyl acrylate. A specific emulsion that can be used in the practice of the invention comprises a terpolymer of vinyl acetate/ethylene/ dioctylmaleate. Another emulsion comprises a vinyl acetate/butyl acrylate copolymer. Mixtures of these emulsions may also be used.

Other preferred resin emulsions that may be used in the practice of the invention are emulsions comprising polyvinyl acetate. Mixtures of two or more polyvinyl acetates and mixtures of polyvinyl acetate and other polymer emulsions and monomers, including but not limited to ethylene vinyl acetate and acrylic monomers, are encompassed. Polyvinyl acetate may be prepared using a continuous or a batch process. Polyvinyl acetate emulsion mixtures wherein the polyvinyl acetates used are prepared by one method or by both methods may be used. Such polyvinyl acetates are commercially available from National Starch and Chemical, Bridgewater, NJ.

Still other preferred adhesives comprise natural polymers. Polysaccharides useful in the invention include starch, dextrin, cellulose, gums or combinations thereof. Particularly useful are the starches and dextrins including native, converted or derivatized. Such starches include those derived from any plant source including maize (corn), potato, wheat, rice, sago, tapioca, waxy maize, sorghum and high amylose starch such as high amylose corn, i.e. starch having at least 45% amylose content by weight. Starch flours may also be used. Also included are the conversion products derived from any of the former bases, such as, for example, dextrins prepared by hydrolytic action of acid and/or heat; fluidity or thin boiling starches prepared by enzyme conversion or mild acid hydrolysis; oxidized starches prepared by treatment with oxidants such as sodium hypochlorite; and derivatized or modified starches such as cationic, anionic, amphoteric, non-ionic, crosslinked and hydroxypropyl starches. Other useful polysaccharides are cellulose materials such as carboxymethylcellulose, hydroxypropyl cellulose and hydroxypropyl methylcellulose, and gums such as guar, xanthan, pectin and carrageenan may also be used in the practice of the invention. Modified starches include, but are not limited to, those modified with an alkyl succinic anhydride. Preferred are octenyl succinic anhydride (OSA) and dodecenyl succinic anhydride (DDSA) modified starches or dextrins.

The adhesive may also contain a filler. The addition of a filler allows for foam generated to remain consistent and stable for several hours. Suitable fillers are those fillers known in the art as adhesives fillers and include polysaccharides, calcium carbonate, clay, mica, nut shell flours, silica, talc and wood flour.

In addition to fillers, other additives typical of adhesive compositions may be added to the foamable composition. Said additives include, but are not limited to, plasticizers, acids, waxes, tackifiers, defoamers, preservatives, bases such as sodium hydroxide, dyes, pigments, UV indicators, crosslinkers, humectants and other additives commonly used in the art.

The adhesive may also contain a surface-active agent. Examples of surface-active agents include anionic, cationic, amphoteric, or nonionic surfactants, or mixtures thereof. Suitable anionic surfactants include, alkyl sulfonates, alkylaryl sulfonates, alkyl sulfates, sulfates of hydroxylalkanols, alkyl and alkylaryl disulfonates, sulfonated fatty acids, sulfates and phosphates of polyethoxylated alkanols and alkylphenols, and esters of sulfosuccinic acid. Suitable cationic surfactants include, alkyl quaternary ammonium salts, and alkyl quaternary phosphonium salts. Suitable non-ionic surfactants include the addition products of 5 to 50 moles of ethylene oxide adducted to straight-chain and branched-chain alkanols having 6 to 22 carbon atoms, alkylphenols, higher fatty acids, higher fatty acid amines, primary or secondary higher alkyl amines, and block copolymers of propylene oxide with ethylene oxide, and mixtures thereof. When used, the surface active agent will typically be added in amounts up to about 20% by weight, based on the foamable composition as a whole, more usually in amounts of from about 0.05 to about 20% by weight, and preferably from 0.2 to 2% by weight.

Preservatives for use herein include those conventionally used in aqueous adhesives such as benzoates, amides and fluorides such as sodium fluoride. Also included are the hydroxybenzoic acid esters such as p-hydroxybenzoic acid methyl ester or p-hydroxybenzoic butyl ester. Commercially available preservatives which may be used in the practice of the invention include KATHON LXE sold by Rohm & Haas Company and Nipacide OBS sold by Clariant. The preservative will generally be included in amounts of from 0.05% to about 0.2% by weight.

The foamable adhesive composition of the invention is foamed by the addition of energy, by means known in the art such as, but not limited to, by mechanical and/or chemical means. Air or other gases are added to the foamable adhesive composition along with the addition of said energy to produce a stable, consistent foamed adhesive. Preferably air is used to produce the foamed adhesive. The adhesive foam may be produced by mechanical means such as mechanical stirring or agitation, introduction of gases or by chemical means.

The amount of air dispersed in the adhesive can vary depending on the particular formulation, but will generally be from about 10% (by volume) up to about 50% (by volume) or greater. The adhesive may be applied by any method known in the art. Typically the substrate material is coated with up to about 2½ to about 6 wet mils of foamed adhesive, most typically about 3 wet mils of foamed adhesive.

The adhesive may be applied by any method known in the art. Preferably, the foamed adhesive is applied using a roll coater, also referred to in the art as a glue spreader.

The invention is illustrated by the following non-limiting examples.

### EXAMPLES

### Example 1

An adhesive composition was prepared using 29.8% of a polyvinyl acetate prepared using batch polymerization process, 54.7% of a polyvinyl acetate prepared using a continuous polymerization process, 9.9% corn starch, 5.4% of a plasticizer and 0.1% of a preservative. This adhesive was foamed to 40% by volume using a Hansa foaming unit.

### Example 2

An adhesive comprising 56.9% by weight of an ethylene/vinyl acetate/acrylic terpolymer (46% vinyl acetate, 36% dioctylmaleate, 17% ethylene) and 22% by weight of a vinyl acetate/acrylic copolymer (25% vinyl acetate and 75% butyl acrylate), 10.3% by weigh of a plasticizer (Benzoflex 50, a 50:50 blend of diethylene/dipropylene glycol dibenzoate available from Velsicol and from Kalama Chemical), 8.3% by weight of an aliphatic hydrocarbon tackifier (Picconol, available from Hercules, Inc.), 0.15% by weight of a preservative (Kathon LX, available from Rohm and Haas Co.) was prepared. This adhesive was foamed to 30% by volume using a Hansa foaming unit.

### Example 3

The foamed adhesives of each of Examples 1 and 2 were used to coat the outside of the end sheets of a book block. Immediately following coating of the adhesive onto the paper substrate the adhesive present on the paper substrate was brought in contact with the case by inserting the adhesive coated book block into a preformed case. The bonded substrates were allowed to set for one hour at room temperature. Bond strength and % fiber test was tested. 100% fiber tear was observed.

1. A method for casing-in a hardcover book comprising the steps of:
(a) applying a foamed water-based adhesive to the outside of the first and last pages of a book block;
(b) inserting the adhesive coated book block into a preformed case in the position in which the two are to be adhered; and
(c) pressing together the book block and case to bond the book block to the case.

2. The method of claim 1 wherein the adhesive comprises a synthetic resin.

3. The method of claim 1 wherein the adhesive comprises a vinyl acetate copolymer resin.

4. The method of claim 1 wherein the adhesive comprises polyvinyl acetate resin.

5. The method of claim 1 wherein the adhesive comprises an ethylene vinyl acetate resin.

6. The method of claim 1 where the adhesive is foamed from about 10 to about 50% by volume.

7. The method of claim 1 wherein the adhesive is foamed to from about 30 to about 40% by volume.

8. A book comprising a case bound to a book block, wherein the case is bonded to the book block with a foamed water based adhesive.

9. The book of claim 8 wherein the adhesive comprises a synthetic resin.

10. The book of claim 8 wherein the adhesive comprises a vinyl acetate copolymer resin.

11. The book of claim 8 wherein the adhesive comprises polyvinyl acetate resin.

12. The book of claim 8 wherein the wherein the adhesive comprises an ethylene vinyl acetate resin.

13. The book of claim 8 wherein the adhesive is foamed from about 10 to about 50% by volume.

14. The book of claim 8 wherein the adhesive is foamed to about 30 to about 40% by volume.
